(19) United States
(12) Patent Application Publication
(10) Pub. No.: US 2008/0239508 A1
(43) Pub. Date: Oct. 2, 2008

(54) METHOD FOR CONTROLLING MOVEMENTS OF AN OPTICAL ZOOM DEVICE

(75) Inventor: Qi-Da Guan, Foshan (CN)

Correspondence Address: PCE INDUSTRY, INC.;ATT. CHENG-JU CHIANG, 458 E. LAMBERT ROAD, FULLERTON, CA, 92835, US

(73) Assignees: PREMIER IMAGE TECHNOLOGY(China) LTD., Foshan City (CN); HON HAI PRECISION INDUSTRY CO., LTD., Tu-Cheng (TW)

(21) Appl. No.: 11/871,928

(22) Filed: Oct. 12, 2007

(30) Foreign Application Priority Data
Mar. 28, 2007 (CN) 200710200342.8

(51) Int. Cl. G02B 15/14

(52) U.S. Cl. 359/696

(57) ABSTRACT

A method for controlling movements of an optical zoom device, the method includes the steps of: setting a timer to zero, and setting a time limit; checking whether the wide-angle button or the telephoto button is pressed; starting the timer and moving the optical zoom device to a point between the current position and the next position in a direction corresponding to the pressed wide-angle button or the pressed telephoto button if the wide-angle button or the telephoto button is pressed; checking the timer to determine whether the time on the timer is less than the time limit; checking whether the pressed button is released if the time on the timer is less than the time limit; confirming a position which is nearest to the optical zoom device along the direction of current movement if the pressed button is released; and moving the optical zoom device to the confirmed position.

### BACKGROUND OF THE INVENTION

1. Field of the Invention

The present invention generally related to methods for controlling movements of an optical zoom device, and more particularly to a method for controlling movements of an optical zoom device in a digital image capturing device.

2. Description of Related Art

Currently, a digital image capturing device with an optical zoom device is popularly used in digital products, such as a digital camera. Usually, zooming in/out an optical zoom lens of the optical zoom device is implemented by controlling buttons on the digital image capturing device.

One method for controlling movements of the optical zoom device includes the steps of controlling the optical zoom device to move forward or backward by holding a zoom or wide angle button down, and stopping movement of the optical zoom device by releasing the button. However, such method has some disadvantages. For example, there is usually a delay time between when the button is released and when the optical zoom device ceases movement, which results in the optical zoom device coming to rest at a position other than the one desired, and a user must repeatedly and alternately push the zoom and wide angle buttons until the desired position of the lens is achieved.

Accordingly, what is needed is a method for controlling movements of an optical zoom device, which can accurately position the optical zoom device with few adjustments required by a user.

### SUMMARY OF THE INVENTION

One preferred embodiment provides a method for controlling movements of an optical zoom device. The optical zoom device applied in a digital image capturing device includes a wide-angle button, a telephoto button and an optical zoom. The optical zoom includes a plurality of positions for the optical zoom device to be moved. The method includes the steps of: setting a timer, which is configured to time how long the W or T button is pressed, to zero, and setting a time limit; checking whether the wide-angle button or the telephoto button is pressed; starting the timer and moving the optical zoom device to a point between the current position and the next position in a direction corresponding to the pressed wide-angle button or the pressed telephoto button if the wide-angle button or the telephoto button is pressed; checking the timer to determine whether the time on the timer is less than the time limit; checking whether the pressed button is released if the time on the timer is less than the time limit; confirming a position which is nearest to the optical zoom device along the direction of current movement if the pressed button is released; and moving the optical zoom device to the confirmed position.

Another preferred embodiment provides a method for controlling movements of an optical zoom device. The optical zoom device applied in a digital image capturing device includes a wide-angle button, a telephoto button and an optical zoom. The optical zoom includes a plurality of positions for the optical zoom device to be moved. The method includes the steps of: setting a timer, which is configured to time how long the W or T button is pressed, to zero, and setting a time limit; checking whether the wide-angle button or the telephoto button is pressed; starting the timer and moving the optical zoom device to a point between the current position and the next position in a direction corresponding to the pressed wide-angle button or the pressed telephoto button if the wide-angle button or the telephoto button is pressed; checking the timer to determine whether the time on the timer, which is equal to the time the wide-angle button or the telephoto button is pressed, is less than the time limit; continuously moving the optical zoom device if the time on the timer is not less than the time limit; checking whether the pressed button is released; stopping moving the optical zoom device if the pressed button is released; confirming a position which is nearest to the optical zoom device along the direction of current movement; and moving the optical zoom device to the confirmed position.

Other systems, methods, features, and advantages will be or become apparent to one skilled in the art upon examination of the following drawings and detailed description.

### BRIEF DESCRIPTION OF THE DRAWINGS

FIG. 1 is flowchart of a method for controlling movements of an optical zoom device in accordance with one preferred embodiment; and

FIG. 2 is a schematic diagram of positions of an optical zoom.

### DETAILED DESCRIPTION OF THE INVENTION

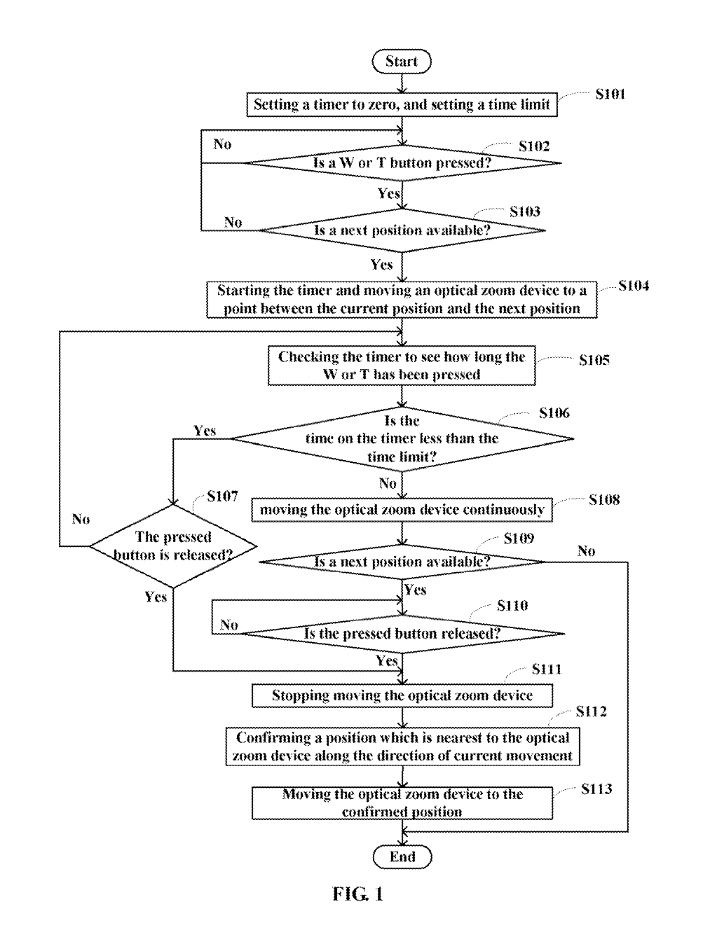

FIG. 1 is flowchart of a method for controlling movements of an optical zoom device in accordance with one preferred embodiment. The preferred embodiment mainly applied in a digital image capturing device that includes a drive set, several buttons, an optical zoom device, an optical zoom, and a digital signal process (DSP) system. The optical zoom device mainly includes an optical zoom lens, and a charge coupled device. The optical zoom includes a plurality of positions for the optical zoom device to be moved. The buttons mainly include a wide-angle (W) button for zooming out with the optical zoom lens (in other words, moving the lens to be nearer to the digital imaging device) and a telephoto (T) button for zooming in with the optical zoom lens (in other words, moving the lens to be further away from the digital imaging device). With the present invention if a user just taps a button (W or T button) then the optical zoom device is moved to a next position. If the user presses the button longer than a predetermined time then the optical zoom device will engage in continuous movement until the button is released or until there are no more positions available in the desired direction. If the button is released at a time when the optical zoom device is between two positions, the optical zoom device will be adjusted to come to rest at the next position along the direction of current movement.

In step S101, setting a timer to zero, and setting a time limit. The timer is used for timing how long the W or T button is pressed.

In step S102, checking if the W or T button is pressed. If no, repeat step S102. If yes, then go to step S103.

In step S103, checking if a next position of the optical zoom is available in the direction corresponding to the pressed W or T button. If no, return to step S102. If yes, then go to step S104.

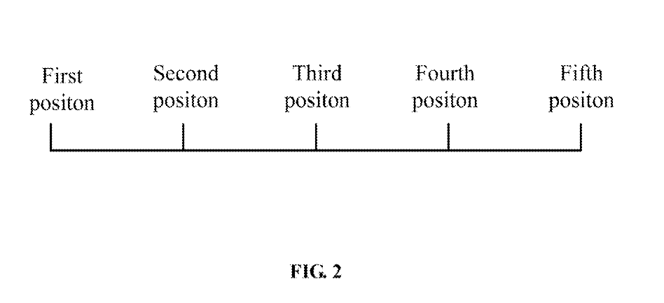

In step S104, starting the timer and moving the optical zoom device to a point between the current position and the next position in the direction corresponding to the pressed W or T button. For example, the optical zoom includes five positions as indicated in FIG. 2, and is initially in the second position. If the optical zoom device is electrified and moved toward the fifth position, the optical zoom device stops at a point between the second position and the third position in the step S104. In the preferred embodiment, the optical zoom device is moved in the corresponding direction of zooming in/out the optical zoom lens according to the pressed button. For example, if the W button is pressed in the step S102, the optical zoom device is moved toward a lower numbered position; or if the T button is pressed in the step S102, the optical zoom device is moved toward a higher number position.

In step S105, checking the timer to see how long the W or T has been pressed.

In step S106, determining if the time on the timer is less than the time limit. If yes, go to step S107. If no, go to step S108.

In step S107, checking if the pressed button is released. If no, return to step S105. If yes, go to step S112.

In step S108, moving the optical zoom device continuously. The optical zoom device keeps moving until the pressed button is released or there is no next position available along the direction of current movement.

In step S109, checking if a next position of the optical zoom is available along the direction of current movement. If yes, go to step S110. If no, the procedure ends with the optical zoom device staying at the current position.

In step S110, checking if the pressed button is released. If no, repeat step S110. If yes, go to step S111.

In step S111, stopping moving of the optical zoom device.

In step S112, confirming a position which is nearest to the optical zoom device along the direction of current movement. For example, the optical zoom device is initially in the second position, if the optical zoom device is electrified and moved toward the fifth position after the W or T button is pressed, and if the pressed button is released when the optical zoom device is currently at a point between the third position and the fourth position, thus, the nearest position in the optical zoom is confirmed to be the fourth position.

In step S113, moving the optical zoom device to the confirmed position.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A method for controlling movements of an optical zoom device, the optical zoom device applied in a digital image capturing device comprising a wide-angle button, a telephoto button and an optical zoom, the optical zoom comprising a plurality of positions for the optical zoom device to be moved, the method comprising the steps of:
setting a timer, which is configured to time how long the W or T button is pressed, to zero, and setting a time limit;
checking whether the wide-angle button or the telephoto button is pressed;
starting the timer and moving the optical zoom device to a point between the current position and the next position in a direction corresponding to the pressed wide-angle button or the pressed telephoto button if the wide-angle button or the telephoto button is pressed;
checking the timer to determine whether the time on the timer is less than the time limit;
checking whether the pressed button is released if the time on the timer is less than the time limit;
confirming a position which is nearest to the optical zoom device along the direction of current movement if the pressed button is released; and
moving the optical zoom device to the confirmed position.

2. The method according to claim 1, further comprising a step of checking whether a next position of the optical zoom is available in the direction corresponding to the pressed wide-angle button or the pressed telephoto button before the step of starting the timer.

3. The method according to claim 1, further comprising a step of returning to the step of checking the timer if the pressed button is not released after the step of checking whether the pressed button is released.

4. The method according to claim 1, further comprising a step of continuously moving the optical zoom device until the pressed button is released or until there is no more position available along the direction of current movement if the time on the timer is not less than the time limit.

5. A method for controlling movements of an optical zoom device, the optical zoom device applied in a digital image capturing device comprising a wide-angle button, a telephoto button and an optical zoom, the optical zoom comprising a plurality of positions for the optical zoom device to be moved, the method comprising steps of:
setting a timer, which is configured to time how long the W or T button is pressed, to zero, and setting a time limit;
checking whether the wide-angle button or the telephoto button is pressed;
starting the timer and moving the optical zoom device to a point between the current position and the next position in a direction corresponding to the pressed wide-angle button or the pressed telephoto button if the wide-angle button or the telephoto button is pressed;
checking the timer to determine whether the time on the timer, which is equal to the time the wide-angle button or the telephoto button is pressed, is less than the time limit;
continuously moving the optical zoom device if the time on the timer is not less than the time limit;
checking whether the pressed button is released;
stopping moving the optical zoom device if the pressed button is released;
confirming a position which is nearest to the optical zoom device along the direction of current movement; and
moving the optical zoom device to the confirmed position.

6. The method according to claim 5, further comprising a step of checking whether the pressed button is released if the time on the timer is less than the time limit and going to the confirming step if the pressed button is released.

7. The method according to claim 6, further comprising a step of returning to the step of checking the timer if the time on the timer is less than the time limit and the pressed button is not released.
